(19) United States
(12) Patent Application Publication
(10) Pub. No.: US 2026/0081368 A1
(43) Pub. Date: Mar. 19, 2026

(54) CONNECTOR AND MANUFACTURING METHOD THEREOF

(71) Applicant: Japan Aviation Electronics Industry, Ltd., Tokyo (JP)

(72) Inventor: Masataka Sato, Tokyo (JP)

(73) Assignee: Japan Aviation Electronics Industry, Ltd., Tokyo (JP)

(21) Appl. No.: 19/299,831

(22) Filed: Aug. 14, 2025

(30) Foreign Application Priority Data
Sep. 13, 2024 (JP) 2024-159169

(51) Int. Cl. H01R 4/60; H01R 43/16

(52) U.S. Cl. CPC H01R 4/60; H01R 43/16

(57) ABSTRACT

A connector includes a housing having a flat plate shape and a plurality of contact accommodations that penetrate the housing in the thickness direction. A plurality of contacts are respectively accommodated in the contact accommodations of the housing. Each contact includes two metal terminals spaced apart from each other in the thickness direction of the housing, a tubular coupling member that is easily elastically deformable and couples the two metal terminals, and a conductive fluid filling an internal space of the coupling member. The two metal terminals are electrically connected to each other through the conductive fluid. A gas is present in the internal space of the coupling member. The two metal terminals are configured to approach each other in the thickness direction of the housing with compression of the gas and elastic deformation of the coupling member.

### INCORPORATION BY REFERENCE

This application is based upon and claims the benefit of priority from Japanese patent application No. 2024-159169, filed on Sep. 13, 2024, the disclosure of which is incorporated herein in its entirety by reference.

### BACKGROUND

The present disclosure relates to a connector and a method of manufacturing the same. As shown in FIG. 13 of the present application, Patent Literature 1 discloses a socket 100 for electronic components for connecting an electronic component such as a semiconductor package to a circuit board. The socket 100 for electronic components includes a housing 103 that includes a side wall 101 and a bottom wall 102, and a plurality of terminals 104 that are disposed penetrating the bottom wall 102 of the housing 103.

Each of the terminals 104 includes a contact part 105 configured to come into contact with an electrode of an electronic component, and a connection part 106 configured to be connected to a land of the circuit board. The contact part 105 is bent in a convex shape so that the contact part 105 reliably comes into electric contact with an electrode of an electronic component, and it is supported by an arm-shaped part 107 that is easily elastically deformable.

Patent Literature 1: Japanese Unexamined Patent Application Publication No. 2012-174617

### SUMMARY

In the structure of the above-described Patent Literature 1, the arm-shaped part 107 needs to be largely curved in order to increase the strokes of the contact part 105, which hinders the downsizing of the terminal 104. Thus, there is room for improvement concerning reducing the pitch of the socket 100 for electronic components.

An object of the present disclosure is to provide a technique to reduce the pitch of a connector.

There is provided a connector including a housing having a flat plate shape and including a plurality of contact accommodations penetrating the housing in a thickness direction, and a plurality of contacts to be respectively accommodated in the plurality of contact accommodations of the housing, wherein each of the contacts includes two metal terminals spaced apart from each other in the thickness direction of the housing, a coupling member in a tubular shape being easily elastically deformable and coupling the two metal terminals, and a conductive fluid filling an internal space of the coupling member, the two metal terminals are electrically connected to each other through the conductive fluid, a gas is present in the internal space of the coupling member, and the two metal terminals are configured to approach each other in the thickness direction of the housing with compression of the gas and elastic deformation of the coupling member.

According to the present disclosure, it is capable of reducing the pitch of a connector.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of an interposer (first embodiment);

FIG. 2 is a partially cutout perspective view of the interposer (first embodiment);

FIG. 3 is a perspective view of a contact (first embodiment);

FIG. 4 is a side cross-sectional view of the interposer (first embodiment);

FIG. 5 is a side cross-sectional view of the interposer (first embodiment);

FIG. 6 is a side cross-sectional view of the interposer (first embodiment);

FIG. 7 is a manufacturing flow of the interposer (first embodiment);

FIG. 8 is a partially cutout perspective view of an interposer (second embodiment);

FIG. 9 is a manufacturing flow of the interposer (second embodiment);

FIG. 10 is a partially cutout perspective view of an interposer (third embodiment);

FIG. 11 is a partial plan view of the interposer (third embodiment);

FIG. 12 is a manufacturing flow of the interposer (third embodiment); and

FIG. 13 is a view showing a simplified version of FIG. 5 of Patent Literature 1.

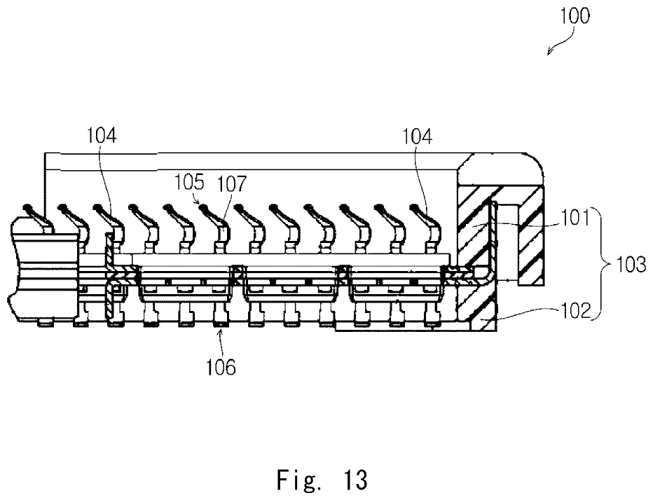

### DESCRIPTION OF EMBODIMENTS

Hereinafter, the present invention will be described through embodiments. However, the invention according to the claims is not limited to the embodiments described below. In addition, not all of the configurations described in the embodiments are necessarily essential as means for solving the problems. For clarity of explanation, the following description and drawings are partially omitted or simplified as appropriate. In the drawings, the same reference numerals are given to the same elements, and redundant explanation is omitted as needed.

In the following embodiments, for convenience of explanation, the description may be divided into a plurality of sections or embodiments when necessary. Unless explicitly stated otherwise, these are not independent of each other, but may be related as modifications, applications, detailed explanations, or supplementary explanations of one another. Further, in the following embodiments, when referring to numerical values such as the number, amount, quantity, or range of components, unless explicitly specified or clearly limited to a specific number in principle, such numbers are not limited to the specified values, and may include values greater or less than the stated ones.

Furthermore, in the following embodiments, unless explicitly stated or clearly considered essential in principle, each component (including operational steps and the like) is not necessarily essential.

Likewise, when referring to the shape, positional relationship, or the like of components, unless explicitly stated or clearly considered otherwise in principle, such descriptions shall be construed to include substantially similar or approximate configurations. The same applies to numerical references such as the number, value, quantity, or range.

### First Embodiment

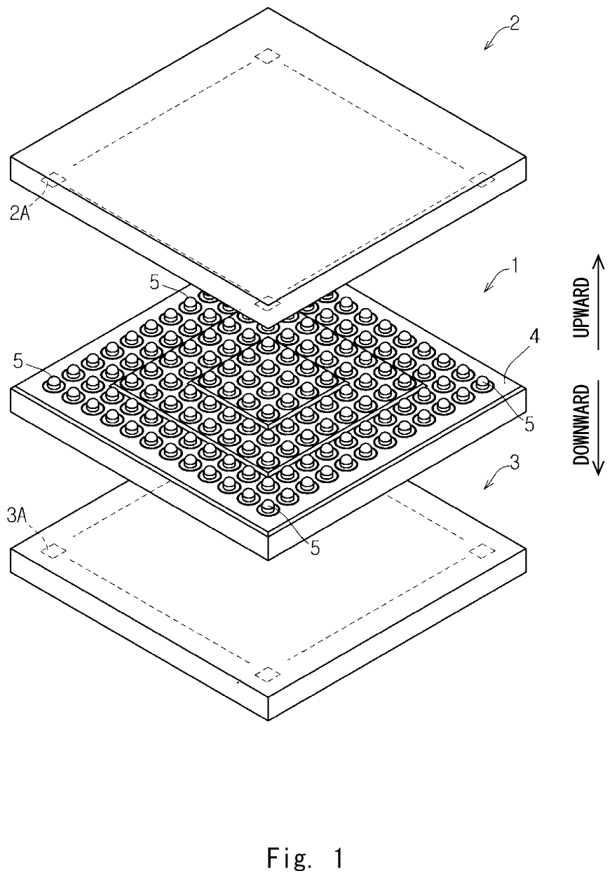

A first embodiment of the present disclosure is described hereinafter with reference to FIGS. 1 to 7. FIG. 1 shows an interposer 1. The interposer 1 is one specific example of a connector. The interposer 1 typically connects an LGA (Land Grid Array) package 2 to a rigid board 3. Thus, the interposer 1 is also called an LGA socket.

The LGA package 2 is one specific example of an electronic component. The LGA package 2 is a semiconductor package where a plurality of lands 2A are disposed in a grid pattern.

The rigid board 3 is one specific example of a circuit board. The rigid board 3 is a board where a plurality of lands 3A are disposed in a grid pattern. The rigid board 3 is typically a paper phenolic board or a glass epoxy board.

In this embodiment, the number of interposes 1 is typically from 3,000 to 10,000. The number of interposes 1, however, may be less than 3,000 or more than 10,000.

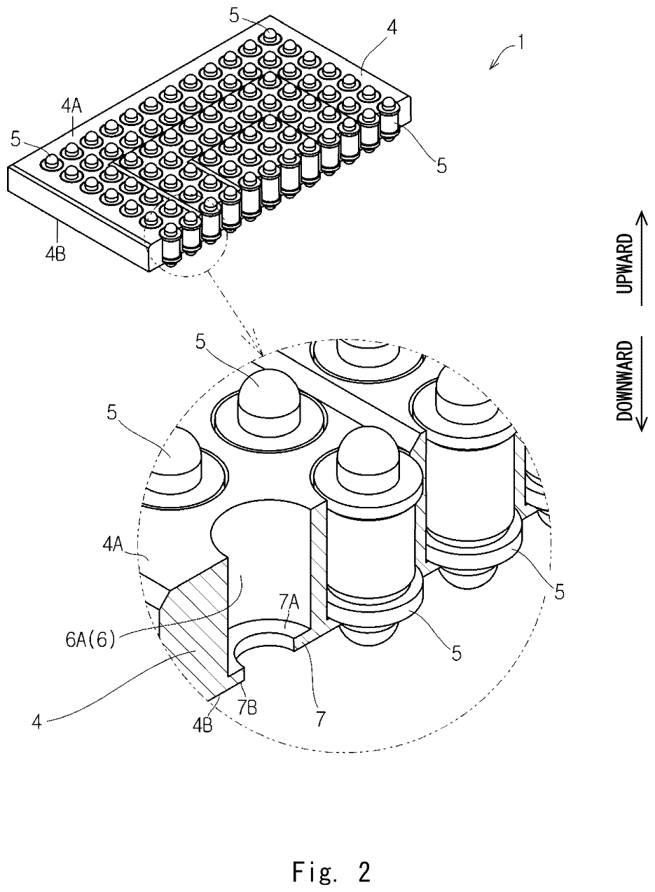

As shown in FIG. 1 and FIG. 2, the interposer 1 includes a housing 4 and a plurality of contacts 5 held by the housing 4. The interposer 1 may further include a positioning guide for positioning the LGA package 2 with respect to the housing 4. Alternatively, the housing 4 may have a function of positioning the LGA package 2 with respect to the housing 4. In this embodiment, the plurality of contacts 5 are disposed in a grid pattern. The pitch of the plurality of contacts 5 is set to 1 mm or less, for example.

### Housing 4

As shown in FIG. 2, the housing 4 has a flat plate shape and includes a plurality of contact accommodations 6 that penetrate the housing 4 in the thickness direction of the housing 4. The thickness direction of the housing 4 is also referred to hereinafter as a vertical direction. The vertical direction includes upward that is a direction of viewing the LGA package 2 from the interposer 1 and downward that is a direction of viewing the interposer 1 from the LGA package 2. The vertical direction and the upward and downward directions are terms to be used for the convenience of description, and they do not limit the position of the interposer 1 when it is actually used. The housing 4 includes a housing upper surface 4A facing upward and a housing lower surface 4B facing downward. Thus, each contact accommodation 6 opens in the housing upper surface 4A and the housing lower surface 4B. Each contact accommodation 6 has a columnar shape extending along the vertical direction. To be specific, an inner peripheral surface 6A of the contact accommodation 6 has a perfect circle shape when viewed from above.

At a lower end of the inner peripheral surface 6A of each contact accommodation 6, a ring-shaped contact receiving flange 7 that projects inward in the radial direction is formed. The contact receiving flange 7 has a flange upper surface 7A facing upward and a flange lower surface 7B facing downward. The flange lower surface 7B is flush with the housing lower surface 4B. An inner peripheral surface of the contact receiving flange 7 has a perfect circle shape when viewed from above.

The housing 4 is made of an insulating material that is easily elastically deformable such as silicone rubber, for example. The housing 4 is thereby flexibly deformable along the curve of the LGA package 2 and the rigid board 3. Alternatively, the housing 4 may be made of an insulating material that is not easily elastically deformable such as LCP (Liquid Crystal Polymer).

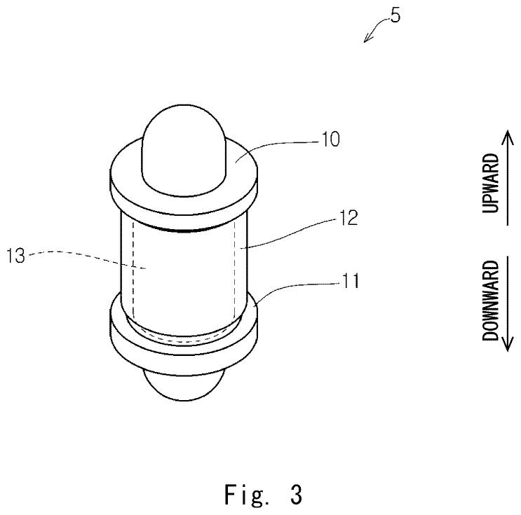

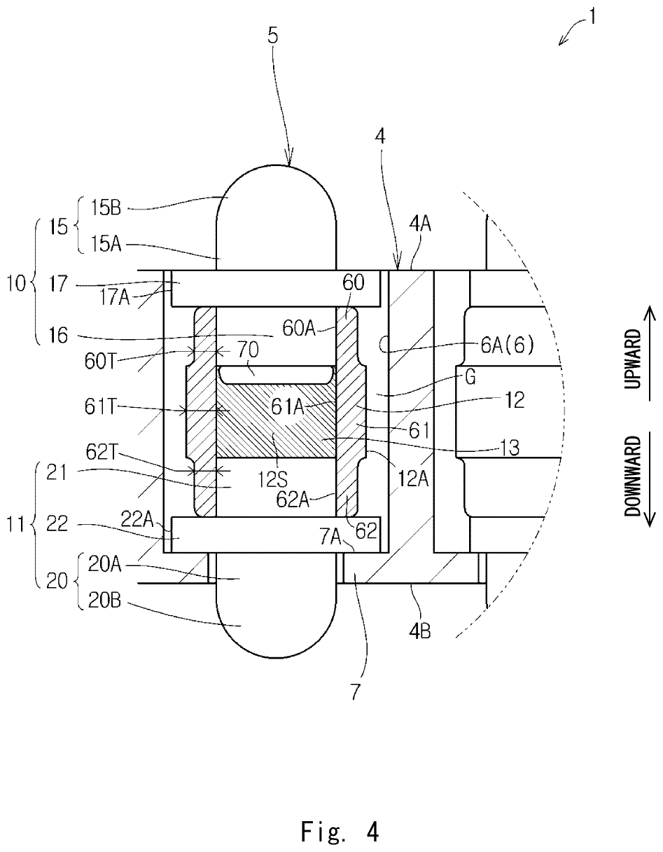

As shown in FIG. 3 and FIG. 4, each contact 5 includes an upper terminal 10, a lower terminal 11, a tube 12, and a liquid metal 13.

### Upper Terminal 10, Lower Terminal 11

The upper terminal 10 and the lower terminal 11 are specific examples of metal terminals. The upper terminal 10 is one specific example of a first metal terminal. The lower terminal 11 is one specific example of a second metal terminal. The upper terminal 10 and the lower terminal 11 are typically made of copper or copper alloy. The upper terminal 10 and the lower terminal 11 are disposed in such a way that they are opposed to each other in the vertical direction. The upper terminal 10 and the lower terminal 11 are configured as separate parts.

### Upper Terminal 10

As shown in FIG. 4, the upper terminal 10 includes a contact part 15, a press-fit part 16, and a large-diameter part 17. The contact part 15, the large-diameter part 17, and the press-fit part 16 are disposed downward in this recited order. The contact part 15 projects upward from the large-diameter part 17. The press-fit part 16 projects downward from the large-diameter part 17. In other words, the contact part 15 and the press-fit part 16 project in opposite directions to each other from the large-diameter part 17. Thus, the contact part 15 and the press-fit part 16 are disposed back-to-back with the large-diameter part 17 interposed therebetween.

The contact part 15 includes a cylindrical portion 15A having an outer peripheral surface that is straight in the vertical direction, and a hemispherical portion 15B that is convex upward.

The press-fit part 16 is formed in a cylindrical shape having an outer peripheral surface that is straight in the vertical direction.

The large-diameter part 17 is formed in a cylindrical shape having an outer peripheral surface 17A that forms a perfect circle in a plan view. The diameter of the large-diameter part 17 is greater than the diameter of the cylindrical portion 15A of the contact part 15. The diameter of the large-diameter part 17 is also greater than the diameter of the press-fit part 16.

### Lower Terminal 11

The lower terminal 11 includes a contact part 20, a press-fit part 21, and a large-diameter part 22. The contact part 20, the large-diameter part 22, and the press-fit part 21 are disposed upward in this recited order. The contact part 20 projects downward from the large-diameter part 22. The press-fit part 21 projects upward from the large-diameter part 22. In other words, the contact part 20 and the press-fit part 21 project in opposite directions to each other from the large-diameter part 22. Thus, the contact part 20 and the press-fit part 21 are disposed back-to-back with the large-diameter part 22 interposed therebetween.

The contact part 20 includes a cylindrical part 20A having an outer peripheral surface that is straight in the vertical direction, and a hemispherical part 20B that is convex downward.

The press-fit part 21 is formed in a cylindrical shape having an outer peripheral surface that is straight in the vertical direction.

The large-diameter part 22 is formed in a cylindrical shape having an outer peripheral surface 22A that forms a perfect circle in a plan view. The diameter of the large-diameter part 22 is greater than the diameter of the cylindrical portion 20A of the contact part 20. The diameter of the large-diameter part 22 is also greater than the diameter of the press-fit part 21.

### Tube 12

The tube 12 is one specific example of a coupling member in a tubular shape having flexibility. The tube 12 is made of an easily elastically deformable material such as silicone rubber, for example. The tube 12 is disposed to extend in the vertical direction. The tube 12 is disposed between the upper terminal 10 and the lower terminal 11 and thereby couples the upper terminal 10 and the lower terminal 11. Hereinafter, the radial direction of the tubular tube 12 may simply be referred to as the “radial direction.”

The tube 12 includes an upper thin portion 60, a thick portion 61, and a lower thin portion 62. These portions—upper thin portion 60, thick portion 61, and lower thin portion 62—are disposed downward in this order. The upper thin portion 60, the thick portion 61, and the lower thin portion 62 are integrally formed. The upper thin portion 60 and the lower thin portion 62 are specific examples of the second tubular portion, and the thick portion 61 is a specific example of the first tubular portion.

The upper thin portion 60 is disposed at the upper end of the tube 12. The upper thin portion 60 faces the press-fit portion 16 in the radial direction. The press-fit portion 16 is press-fitted into the upper thin portion 60. Accordingly, the upper terminal 10 is held by the upper thin portion 60 of the tube 12. In addition, the upper thin portion 60 is in contact with the large-diameter portion 17 in the vertical direction. This provides vertical positioning of the upper terminal 10 with respect to the tube 12. The upper thin portion 60 has an inner circumferential surface 60A.

The thick portion 61 is disposed at the center of the tube 12 in the vertical direction.

The thick portion 61 is disposed between the upper thin portion 60 and the lower thin portion 62. The thick portion 61 connects the upper thin portion 60 and the lower thin portion 62 to each other. The thick portion 61 has an inner circumferential surface 61A.

The lower thin portion 62 is disposed at the lower end of the tube 12. The lower thin portion 62 faces the press-fit portion 21 in the radial direction. The press-fit portion 21 is press-fitted into the lower thin portion 62. Accordingly, the lower terminal 11 is held by the lower thin portion 62 of the tube 12. In addition, the lower thin portion 62 is in contact with the large-diameter portion 22 in the vertical direction. This provides vertical positioning of the lower terminal 11 with respect to the tube 12. The lower thin portion 62 has an inner circumferential surface 62A.

The radial thickness 60T of the upper thin portion 60, the radial thickness 61T of the thick portion 61, and the radial thickness 62T of the lower thin portion 62 satisfy the relationship: 60T=62T<61T. That is, the thickness 60T of the upper thin portion 60 is smaller than the thickness 61T of the thick portion 61. Similarly, the thickness 62T of the lower thin portion 62 is smaller than the thickness 61T of the thick portion 61.

The inner diameter of the upper thin portion 60, the inner diameter of the thick portion 61, and the inner diameter of the lower thin portion 62 are equal to one another. Accordingly, the outer diameters of the upper thin portion 60 and the lower thin portion 62 are equal, and both are smaller than the outer diameter of the thick portion 61.

### Liquid Metal 13

The liquid metal 13 is a specific example of a conductive fluid. The liquid metal 13 is filled in an internal space 12S of the tube 12. Specifically, the liquid metal 13 is filled in the internal space 12S that is bounded in the vertical direction by the upper terminal 10 and the lower terminal 11, and in the radial direction by the tube 12. The filling rate of the liquid metal 13 in the internal space 12S is typically set to be 50% or more and less than 100%. The filling rate of the liquid metal 13 in the internal space 12S may be set within a range of 70% to 95%.

The filling rate may also be set within a range of 80% to 90%. The filling rate refers to the ratio of the volume of the liquid metal 13 to the volume of the internal space 12S of the tube 12.

Therefore, it can be said that the internal space 12S of the tube 12 contains the liquid metal 13 and air 70. Likewise, it can also be said that the internal space 12S of the tube 12 is filled with the liquid metal 13 and air 70. The air 70 is a specific example of a gas. The gas may be another type of gas, such as nitrogen gas, instead of the air 70.

The liquid metal 13 is typically made of a metal having the following properties:
It is liquid at 5° C. to 35° C.
It has low electrical resistance
It does not easily vaporize even when heated by the passage of electric current

An example of the liquid metal 13 having the above properties is a liquid metal containing Ga (gallium) and Sn (tin). Further, an example of the liquid metal 13 is a liquid metal containing a eutectic alloy of Ga (gallium), In (indium), and Sn (tin). As this type of liquid metal, Galinstan (registered trade mark) is available commercially. Galinstan is a metal that is liquid at normal temperatures (22° C.), with a boiling point of 1300° C. or higher and a melting point of −19° C. Further, Galinstan forms an oxide film at the contact interface with the air, which functions as a sealing part to thereby control vaporization of a liquid metal.

Parts of the upper terminal 10 and the lower terminal 11 that come into contact with the liquid metal 13, which are the press-fit part 16 of the upper terminal 10 and the press-fit part 21 of the lower terminal 11, may be coated with plating predominantly composed of In or Sn for the purpose of improving wettability and contact resistance with the liquid metal 13.

The contact angle of the liquid metal 13 with respect to the tube 12 is typically less than 35 degrees. The contact angle may also be less than 15 degrees. By achieving such a contact angle, the entire inner circumferential surface 61A of the thick portion 61 can be wetted by the liquid metal 13, and thus electrical conduction between the upper terminal 10 and the liquid metal 13 can be ensured even when air 70 is present in the internal space 12S. For example, when Galinstan described above is used as the liquid metal 13 and silicone rubber is used as the tube 12, the contact angle of the liquid metal 13 with respect to the inner circumferential surface 61A of the thick portion 61 is 13 degrees when the temperature of the liquid metal 13 is 25° C. As shown in FIG. 4, in the unloaded state of the contact 5, the filling rate of the liquid metal 13 is preferably set such that the press-fit portion 16 is wetted by the liquid metal 13.

The viscosity of the liquid metal 13 is appropriately adjustable within the range of not hindering the flowability of the liquid metal 13. Thus, the liquid metal 13 may be paste in an example.

With the above configuration, the upper terminal 10 and the lower terminal 11 are constantly in an electrically conductive state with each other via the liquid metal 13, both before and after use of the interposer 1. The upper terminal 10 and the lower terminal 11 can move closer to each other in the vertical direction while maintaining their conductive state, accompanied by compression of the air 70 and elastic deformation of the tube 12. When the upper terminal 10 and the lower terminal 11 approach each other, a repulsive force acts on them in a direction to separate from each other due to the internal pressure of the air 70 and the elastic restoring force of the tube 12.

### Assembly of Interposer 1

Refer again to FIG. 4. FIG. 4 shows the state where the contact 5 is accommodated in the contact accommodation 6. As shown in FIG. 4, the contact 5 moves downward to the corresponding contact accommodation 6 and is thereby accommodated into the corresponding contact accommodation 6.

The contact 5 is held by the contact receiving flange 7 in the state of being accommodated in the contact accommodations 6. To be specific, the large-diameter part 22 of the lower terminal 11 of the contact 5 comes into contact with the flange upper surface 7A of the contact receiving flange 7 in the vertical direction, and thereby the contact 5 is held by the contact receiving flange 7.

In this state, the contact part 20 of the lower terminal 11 penetrates the contact receiving flange 7 in the vertical direction and is exposed downward beyond the housing lower surface 4B of the housing 4.

On the other hand, the contact part 15 of the upper terminal 10 is exposed upward beyond the housing upper surface 4A of the housing 4. In an example, the contact part 15 of the upper terminal 10 is located upward above the housing upper surface 4A of the housing 4, and the large-diameter part 17 of the upper terminal 10 is located downward below the housing upper surface 4A of the housing 4. In other words, the large-diameter part 17 of the upper terminal 10 is completely accommodated in the contact accommodations 6.

Further, there is a gap G between the inner peripheral surface 6A of the contact accommodation 6 and an outer peripheral surface 12A of the tube 12. This gap G allows the tube 12 to swell outward in the radial direction.

### Use of Interposer 1

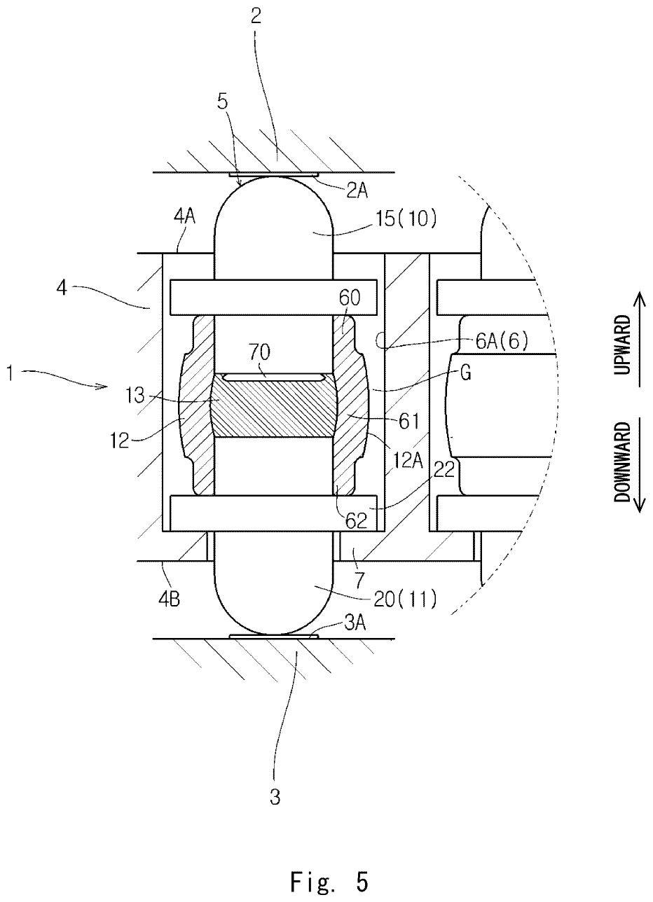

FIG. 5 shows the behavior of the contact 5 during use of the interposer 1. As shown in FIG. 5, the interposer 1 is mounted on the rigid board 3 for use. In an example, the interposer 1 includes a hold-down, which is not shown, and is fixed to the rigid board 3 by soldering of the hold-down to the rigid board 3. As shown in FIG. 5, the contact part 20 of the lower terminal 11 of each contact 5 is in contact with the land 3A of the rigid board 3 in the state where the interposer 1 is mounted on the rigid board 3. In this state, at least in some of the plurality of contacts 5, the large-diameter part 22 of the lower terminal 11 would be spaced upward from the contact receiving flange 7 in order to absorb the curve of the rigid board 3.

To connect the LGA package 2 to the rigid board 3 in this state, the LGA package 2 is pressed against the interposer 1 by handling a clamp, which is not shown. Then, each land 2A of the LGA package 2 comes into contact with the contact part 15 of the upper terminal 10 of the corresponding contact 5 and pushes down the contact part 15. In other words, the upper terminal 10 moves toward the lower terminal 11. As described above, the upper terminal 10 and the lower terminal 11 maintain an electrically conductive state with each other via the liquid metal 13, and the upper terminal 10 moves toward the lower terminal 11 accompanied by compression of the air 70 and elastic deformation of the tube 12. Specifically, as shown in FIG. 5, the thick portion 61 of the tube 12 is elastically deformed so as to bulge outward in the radial direction, and the upper thin portion 60 and the lower thin portion 62 of the tube 12 are compressed in the vertical direction.

In the present embodiment, air 70 is present in the internal space 12S of the tube 12 along with the liquid metal 13. The upper terminal 10 moves toward the lower terminal 11 with compression of the air 70. Therefore, compared to a case in which no air 70 is present in the internal space 12S of the tube 12 and the filling rate mentioned above is 100%, in the present embodiment, the tube 12 is less likely to bulge outward in the radial direction when the upper terminal 10 moves toward the lower terminal 11. As a result, the gap G between the inner circumferential surface 6A of the contact housing chamber 6 and the outer circumferential surface 12A of the tube 12 can be reduced, thereby contributing to a fine-pitch design of the interposer 1.

In the present embodiment, the tube 12 includes the upper thin portion 60 and the lower thin portion 62, and when the upper terminal 10 moves toward the lower terminal 11, the upper thin portion 60 and the lower thin portion 62 are compressed in the vertical direction. By providing the tube 12 with the upper thin portion 60 and the lower thin portion 62, which are actively compressed in the vertical direction, external forces that compress the thick portion 61 in the vertical direction are less likely to act on the thick portion 61 when the upper terminal 10 moves toward the lower terminal 11. Therefore, compared to a case where the tube 12 has a uniform thickness throughout in the vertical direction, in the present embodiment, the tube 12 is less likely to bulge outward in the radial direction when the upper terminal 10 moves toward the lower terminal 11. As a result, the gap G between the inner circumferential surface 6A of the contact housing chamber 6 and the outer circumferential surface 12A of the tube 12 can be reduced, thereby contributing to a fine-pitch design of the interposer 1.

In this manner, each land 2A of the LGA package 2 becomes electrically connected to the corresponding land 3A of the rigid board 3 sequentially through the upper terminal 10, the liquid metal 13, and the lower terminal 11 of the contact 5.

On the other hand, to separate the LGA package 2 from the rigid board 3, the LGA package 2 is brought upward away from the rigid board 3 simply by handling the above-described clamp. As a result, as described above, the upper terminal 10 is pushed back upward by the internal pressure of the air 70 and the elastic restoring force of the tube 12, and the state of the interposer 1 returns to the state shown in FIG. 4.

As described above, according to each contact 5 of the present embodiment, the current path length from each land 2A of the LGA package 2 to the corresponding land 3A of the rigid board 3 is significantly shorter, since the current path extends straight in the vertical direction. Accordingly, excellent high-frequency characteristics are achieved.

Furthermore, since the structure of each contact 5 is simple, it can be said that the interposer 1 also contributes to a low-profile design.

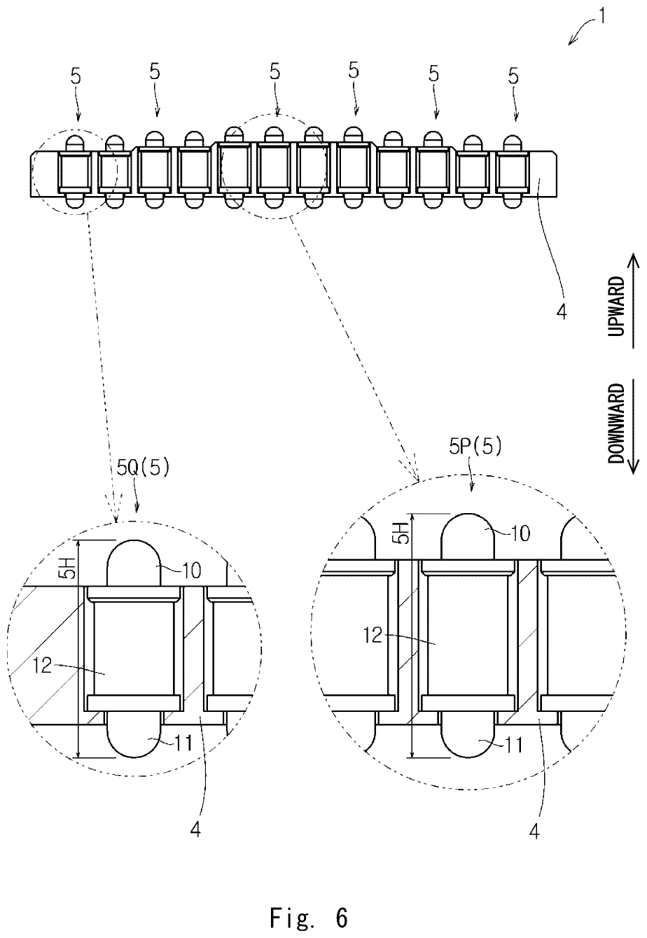

FIG. 6 shows a side cross-sectional view of the interposer. In FIG. 6 and subsequent figures, the shape of the tube 12 is illustrated in a simplified manner. As shown in FIG. 6, the dimension 5H of each contact 5 in the vertical direction is designed to increase toward the center of the interposer 1 when viewed from above. Specifically, the plurality of contacts 5 include a long contact 5P whose dimension 5H in the vertical direction is a first length and a short contact 5Q whose dimension 5H in the vertical direction is a second length that is shorter than the first length. The long contact 5P is disposed at the center of the interposer 1 when viewed from above. The short contact 5Q is disposed on the periphery of the interposer 1 when viewed from above. By changing the length of the tube 12 of each contact 5, the distance between the upper terminal 10 and the lower terminal 11 in each contact 5 is adjusted. This allows absorbing the curve of the LGA package 2 and the rigid board 3 when connecting the LGA package 2 to the rigid board 3.

### Manufacturing Method

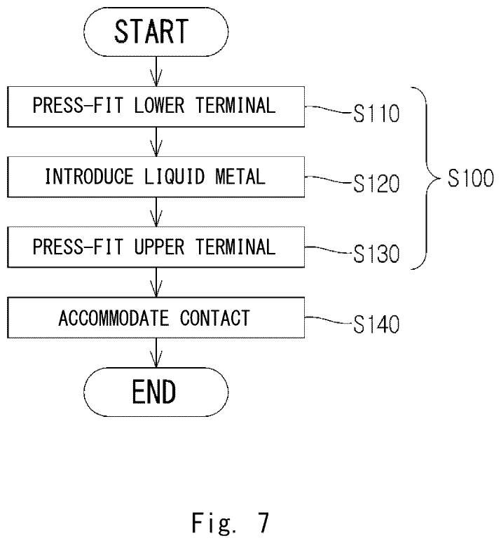

Referring to FIG. 7, a method of manufacturing the interposer 1 is described hereinafter. First, the plurality of contacts 5 are produced (S100). To be specific, the lower terminal 11 is press-fitted into the tube 12 (S110), the liquid metal 13 is introduced into the tube 12 (S120), and the upper terminal 10 is press-fitted into the tube 12 (S130).

Note that, however, the upper terminal 10 may be press-fitted into the tube 12 first, the liquid metal 13 may be introduced into the tube 12 next, and the lower terminal 11 may be press-fitted into the tube 12 after that. Further, the liquid metal 13 may be introduced into the tube 12 after the upper terminal 10 and the lower terminal 11 are press-fitted into the tube 12. In this case, a temporary flow path may be formed to introduce the liquid metal 13 between the upper terminal 10 or the lower terminal 11 and the tube 12. Furthermore, the upper terminal 10 and the lower terminal 11 may be press-fitted into the tube 12 after introducing the liquid metal 13 into the tube 12. In this case, it would be effective to slightly increase the viscosity of the liquid metal 13. After producing the plurality of contacts 5 (S100), each contact 5 is accommodated into the corresponding contact accommodation 6 (S140).

The first embodiment is described above. The above-described first embodiment has the following features.

As shown in FIGS. 1 to 6, the interposer 1 (connector) includes the housing 4 having a flat plate shape including the plurality of contact accommodations 6 penetrating the housing 4 in the thickness direction, and the plurality of contacts 5 to be respectively accommodated in the plurality of contact accommodations 6 of the housing 4. As shown in FIGS. 3 to 5, each of the contacts 5 includes two metal terminals (10, 11) spaced apart from each other in the thickness direction of the housing 4, the tube 12 (coupling member) in a tubular shape being easily elastically deformable and coupling the two metal terminals (10, 11), and the liquid metal 13 (conductive fluid) filling the tube 12. The two metal terminals (10, 11) are electrically connected to each other through the liquid metal 13. Air 70 is present in the internal space 12S of the tube 12. The two metal terminals (10, 11) are configured to approach each other in the thickness direction of the housing 4 with compression of the air 70 and elastic deformation of the tube 12. With this configuration, a fine-pitch design of the interposer 1 can be achieved.

Notably, since the air 70 is compressed when the two metal terminals (10, 11) move closer to each other, outward bulging of the tube 12 in the radial direction can be suppressed. This effectively contributes to the fine-pitch design of the interposer 1.

As described above, air 70 is present in the internal space 12S of the tube 12.

Accordingly, each contact 5 can be said to include the two metal terminals (10, 11), the tube 12, the liquid metal 13, and the air 70.

As also described above, air 70 is present in the internal space 12S of the tube 12.

Therefore, the phrase “the liquid metal 13 is filled in the internal space 12S of the tube 12” means that the liquid metal 13 is filled in the internal space 12S to a degree that allows air 70 to remain therein. The filling rate of the liquid metal 13 in the internal space 12S of the tube 12 is typically set to be 50% or more and less than 100%.

The tube 12 also includes the second tubular portions (60, 62) and the thick portion 61 (first tubular portion). The second tubular portions (60, 62) and the thick portion 61 are disposed at different positions in the thickness direction of the housing 4. The second tubular portions (60, 62) and the thick portion 61 have different thicknesses from each other. With this configuration, when the upper terminal 10 moves toward the lower terminal 11, either one of the second tubular portions (60, 62) or the thick portion 61 can be actively compressed in the vertical direction, thereby suppressing bulging of the tube 12 outward in the radial direction.

The thickness of the second tubular portions (60, 62) is smaller than that of the thick portion 61. With this configuration, when the upper terminal 10 moves toward the lower terminal 11, the second tubular portions (60, 62) are actively compressed in the vertical direction, so that almost no vertical compressive force acts on the thick portion 61. This suppresses the outward bulging of the thick portion 61 in the radial direction.

The second tubular portions (60, 62) are respectively disposed at the two end portions of the tube 12 in the thickness direction of the housing 4. With this configuration, when the upper terminal 10 moves toward the lower terminal 11, the upper or lower end of the tube 12 is actively compressed in the vertical direction.

It should be noted that either or both of the upper thin portion 60 and the lower thin portion 62 may be omitted. Even in such a case, when the two metal terminals (10, 11) move closer to each other, compression of the air 70 suppresses outward bulging of the tube 12 in the radial direction.

Each metal terminal (10, 11) includes a press-fit portion (16, 21) that is press-fitted into the tube 12. The second tubular portions (60, 62) are disposed to face the press-fit portions (16, 21) in the radial direction. With this configuration, when the upper terminal 10 moves toward the lower terminal 11, the second tubular portions (60, 62) are compressed while being radially constrained by the press-fit portions (16, 21). Therefore, when the upper terminal 10 moves toward the lower terminal 11, the second tubular portions (60, 62) can undergo compression in the vertical direction while maintaining a stable posture.

Further, each of the metal terminals (10, 11) includes the press-fit part (16, 21) to be press-fitted into the tube 12. This structure achieves favorable workability when coupling the two metal terminals (10, 11) by the tube 12.

Further, each of the metal terminals (10, 11) includes the large-diameter part (17, 22) having a larger diameter than the press-fit part (16, 21). This structure achieves positioning of the press-fit part (16, 21) with respect to the tube 12 when press-fitting the press-fit part (16, 21) to the tube 12.

Further, each of the metal terminals (10, 11) includes the contact part (15, 20) exposed outward from the housing 4. The press-fit part (16, 21) and the contact part (15, 20) are respectively disposed back-to-back with the large-diameter part (17, 22) interposed therebetween. This structure achieves each of the metal terminals (10, 11) in a simple structure.

Further, each of the metal terminals (10, 11) includes the contact part (15, 20) exposed outward from the housing 4. The press-fit part (16, 21) and the contact part (15, 20) project in opposite directions to each other from the large-diameter part (17, 22). This structure achieves each of the metal terminals (10, 11) in a simple structure.

Further, the contact part (15, 20) has a smaller diameter than the large-diameter part (17, 22). This structure contributes to reducing the weight of the interposer 1.

Further, there is a gap G between the inner peripheral surface 6A of each of the contact accommodations 6 and the outer peripheral surface 12A of the tube 12 of each of the contacts 5. This structure allows elastic deformation of the tube 12 outward in the radial direction.

Further, the interposer 1 is manufactured by attaching any one of the two metal terminals (10, 11) to the tube 12, filling the tube 12 with the liquid metal 13, and attaching the other one of the two metal terminals (10, 11) to the tube 12. This method allows reducing the manufacturing cost of the interposer 1.

### Second Embodiment

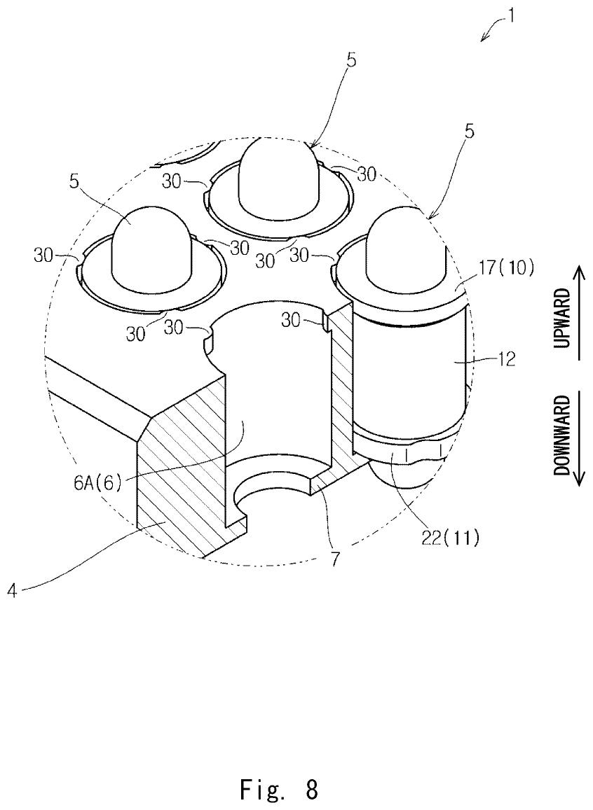

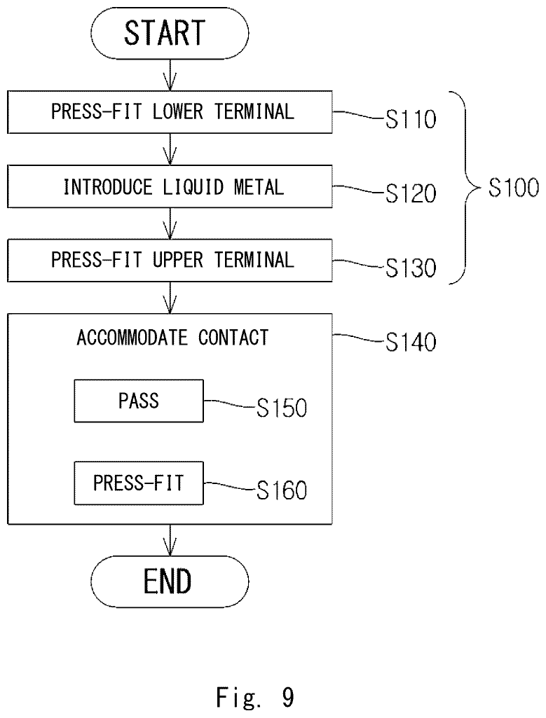

A second embodiment of the present disclosure is described hereinafter with reference to FIG. 8 and FIG. 9. Hereinafter, differences of this embodiment from the above-described first embodiment are mainly described, and redundant description is omitted.

In the above-described first embodiment, as shown in FIG. 4, in the state where the contact 5 is accommodated in the contact accommodation 6, the contact 5 can be easily pulled upward from the contact accommodation 6. Thus, when the interposer 1 is placed upside down, there is a possibility that the contact 5 can unintentionally falls out of the housing 4.

In this embodiment, on the other hand, as shown in FIG. 8, the contact 5 is held by the housing 4 by press-fitting. To be specific, a plurality of inward projections 30 are formed at an upper end of the inner peripheral surface 6A of each contact accommodation 6. In this embodiment, the plurality of inward projections 30 include three inward projections 30.

Alternatively, the plurality of inward projections 30 may include two, or four or more inward projections 30. As shown in FIG. 8, the three inward projections 30 are disposed at regular intervals when viewed from above. The diameter of a circle passing though the inside apexes in the radial direction of the three inward projections 30 before elastic deformation is smaller than the diameter of the large-diameter part 17 of the upper terminal 10. At a lower end of the inner peripheral surface 6A of each contact accommodation 6, the contact receiving flange 7 is formed, just like in the above-described first embodiment. The contact receiving flange 7 is one specific example of a receiving part that receives the large-diameter part 22 of the lower terminal 11.

Then, as shown in FIG. 8, in the state where the contact 5 is accommodated in the contact accommodation 6, the large-diameter part 17 of the upper terminal 10 is press-fitted into the three inward projections 30. In this state, the three inward projections 30 are elastically deformed outward in the radial direction, and an elastic restoring force acts inward in the radial direction on the large-diameter part 17 of the upper terminal 10. By this elastic restoring force, the contact 5 is held by the housing 4.

To connect the LGA package 2 to the rigid board 3 in the state shown in FIG. 8, the LGA package 2 is pressed against the interposer 1 by handling a clamp, which is not shown.

Then, each land 2A of the LGA package 2 comes into contact with the contact part 15 of the upper terminal 10 of the corresponding contact 5 and pushes down the contact part 15. In other words, the upper terminal 10 moves toward the lower terminal 11. By this movement of the upper terminal 10, the above-described press-fit is released, and the large-diameter part 17 of the upper terminal 10 moves downward below the three inward projections 30. When the large-diameter part 17 of the upper terminal 10 moves downward below the three inward projections 30, the three inward projections 30 elastically return to the state before press-fitting and become slightly opposed to the large-diameter part 17 of the upper terminal 10 in the vertical direction. This opposed relation prevents the large-diameter part 17 of the upper terminal 10 from moving upward beyond the three inward projections 30, which prevents the contact 5 from falling out of the contact accommodation 6.

Referring next to FIG. 9, a method of manufacturing the interposer 1 is described hereinafter. Steps S100 to S130 are the same as Steps S100 to S130 in the above-described first embodiment and therefore not redundantly described below. In this embodiment, Step S140 of accommodating each contact 5 into the corresponding contact accommodation 6 is different from Step S140 in the above-described first embodiment. Specifically, Step S140 in this embodiment includes Step S150 for the lower terminal 11 to pass through the three inward projections 30 and Step S160 of press-fitting the large-diameter part 17 of the upper terminal 10 into the three inward projections 30.

The second embodiment is described above. The above-described second embodiment has the following features.

The two metal terminals (10, 11) include the upper terminal 10 (first metal terminal) and the lower terminal 11 (second metal terminal). On the inner peripheral surface 6A of each of the contact accommodations 6, the plurality of inward projections 30 to which the large-diameter part 17 of the upper terminal 10 is to be press-fitted and the contact receiving flange 7 (receiving part) that receives the large-diameter part 22 of the lower terminal 11 are formed.

The large-diameter part 17 of the upper terminal 10 is press-fitted to the plurality of inward projections 30, and thereby the contact 5 is held by the housing 4. This structure improves the handling of the interposer 1. Further, since the press-fit is released when the upper terminal 10 moves toward the lower terminal 11, the upper terminal 10 is allowed to move toward the lower terminal 11.

Further, the interposer 1 is manufactured by attaching any one of the two metal terminals (10, 11) to the tube 12, filling the tube 12 with the liquid metal 13, attaching the other one of the two metal terminals (10, 11) to the tube 12, and press-fitting the large-diameter part 17 of the upper terminal 10 to the plurality of inward projections 30. This method allows reducing the manufacturing cost of the interposer 1.

### Third Embodiment

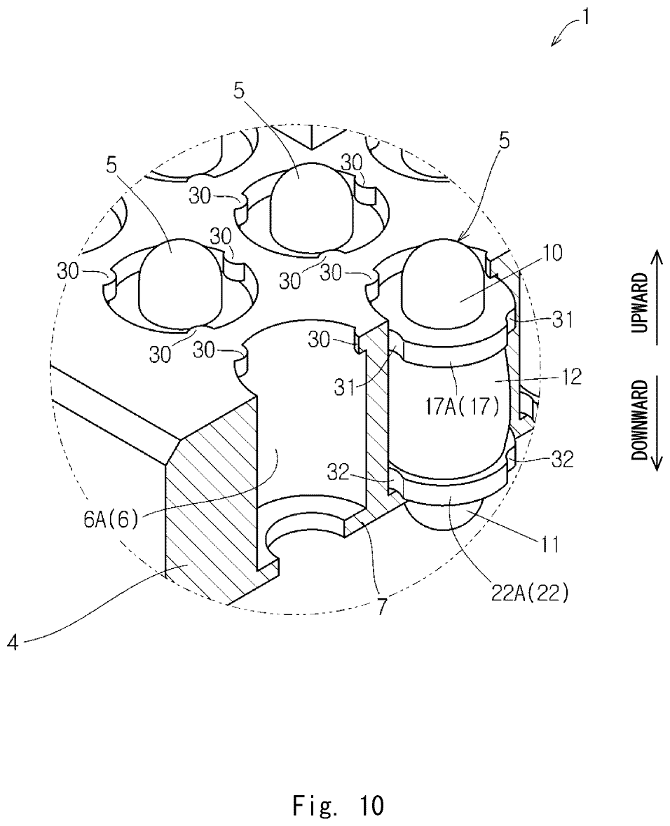

A third embodiment is described hereinafter with reference to FIG. 10 to FIG. 12. Hereinafter, differences of this embodiment from the above-described second embodiment are mainly described, and redundant description is omitted.

In the above-described second embodiment, prior to use of the interposer 1, as shown in FIG. 8, the large-diameter part 17 of the upper terminal 10 is press-fitted to the three inward projections 30, and thereby the contact 5 is held by the housing 4.

In this embodiment, on the other hand, both before and after use of the interposer 1, as shown in FIG. 10, the large-diameter part 17 of the upper terminal 10 is located downward below the three inward projections 30, and thereby the contact 5 is held by the housing 4. In this embodiment, the three inward projections 30 are one specific example of a first receiving part that receives the large-diameter part 17 of the upper terminal 10. The contact receiving flange 7 is one specific example of a second receiving part that receives the large-diameter part 22 of the lower terminal 11. The large-diameter part 17 of the upper terminal 10 and the large-diameter part 22 of the lower terminal 11 are located between the three inward projections 30 and the contact receiving flange 7 in the vertical direction, and thereby the contact 5 is held by the housing 4.

To be specific, on the outer peripheral surface 17A of the large-diameter part 17 of the upper terminal 10, three upper recesses 31 are formed corresponding to the three inward projections 30. The three upper recesses 31 are formed at regular intervals when viewed from above. Likewise, on the outer peripheral surface 22A of the large-diameter part 22 of the lower terminal 11, three lower recesses 32 are formed corresponding to the three inward projections 30. The three lower recesses 32 are formed at regular intervals when viewed from above.

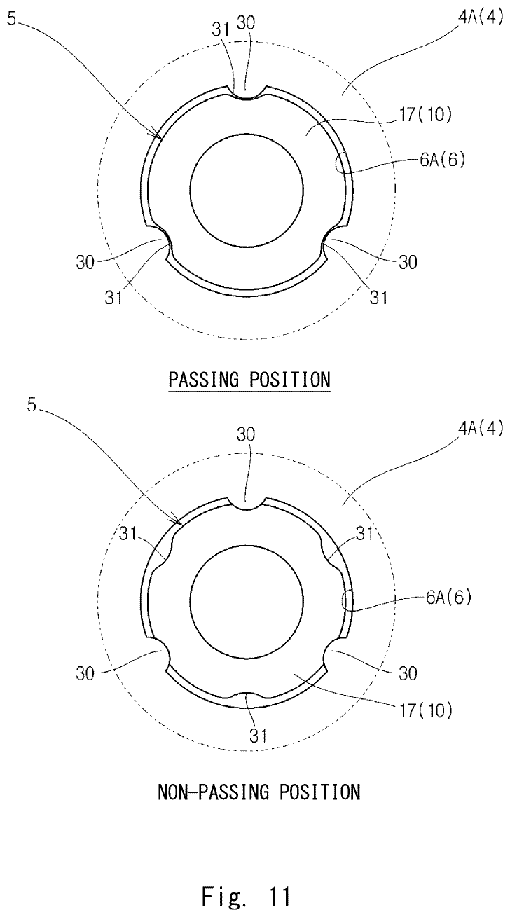

FIG. 11 illustrates two position of the upper terminal 10: a passing position where the large-diameter part 17 of the upper terminal 10 are allowed to pass through the three inward projections 30 in the vertical direction, and a non-passing position where the large-diameter part 17 of the upper terminal 10 are not allowed to pass through the three inward projections 30 in the vertical direction.

In the passing position in FIG. 11, the three upper recesses 31 of the large-diameter part 17 of the upper terminal 10 are respectively aligned with the three inward projections 30, and the three upper recesses 31 of the large-diameter part 17 of the upper terminal 10 and the three inward projections 30 are respectively not opposed to each other in the vertical direction. Thus, in this passing position, the large-diameter part 17 of the upper terminal 10 is allowed to pass through the inside space of the three inward projections 30 without coming into contact with the three inward projections 30.

In the non-passing position in FIG. 11, the contact 5 is rotated by 30 degrees from the passing position. In this position, the three inward projections 30 are opposed to the large-diameter part 17 of the upper terminal 10 in the vertical direction. Thus, in this non-passing position, the large-diameter part 17 of the upper terminal 10 is not allowed to pass through the inside space of the three inward projections 30 without coming into contact with the three inward projections 30.

In this manner, in this embodiment, the upper terminal 10 can switch between the passing position and the non-passing position simply by rotating the upper terminal 10 relative to the three inward projections 30.

As shown in FIG. 10, since the three lower recesses 32 are formed also in the large-diameter part 22 of the lower terminal 11, the large-diameter part 22 of the lower terminal 11 are allowed to pass through the inside space of the three inward projections 30 without coming into contact with the three inward projections 30 by aligning the three lower recesses 32 with the three inward projections 30.

In this structure, to accommodate the contact 5 into the contact accommodation 6, the contact 5 is first inserted into the contact accommodation 6 in the position where the three lower recesses 32 formed in the large-diameter part 22 of the lower terminal 11 are aligned with the three inward projections 30. Next, in the position where the three upper recesses 31 formed in the large-diameter part 17 of the upper terminal 10 are aligned with the three inward projections 30, the upper terminal 10 is pushed down so that the large-diameter part 17 of the upper terminal 10 passes through the inside space of the three inward projections 30. Then, as shown in FIG. 10, the tube 12 is elastically deformed to slightly swell outward in the radial direction. In this state, the upper terminal 10 is rotated relative to the three inward projections 30, so that the position of the upper terminal 10 switches from the passing position to the non-passing position. After that, a downward load on the upper terminal 10 is released. Then, the upper terminal 10 rises by the elastic restoring force of the tube 12, and the large-diameter part 17 of the upper terminal 10 collides with the three inward projections 30. The large-diameter part 17 of the upper terminal 10 and the large-diameter part 22 of the lower terminal 11 are thereby located between the three inward projections 30 and the contact receiving flange 7, so that the contact 5 is held by the housing 4. Note that, in this embodiment, the contact 5 is in a pre-load state in the position where the contact 5 is held by the housing 4. To be specific, as shown in FIG. 10, in the state where the large-diameter part 17 of the upper terminal 10 collides with the three inward projections 30, the elastic energy remains in the tube 12, which continues to push up the upper terminal 10. This prevents the contact 5 from moving about in the contact accommodation 6 during handling of the interposer 1. Note that, however, the contact 5 is not necessarily in a pre-load state in the position where the contact 5 is held by the housing 4.

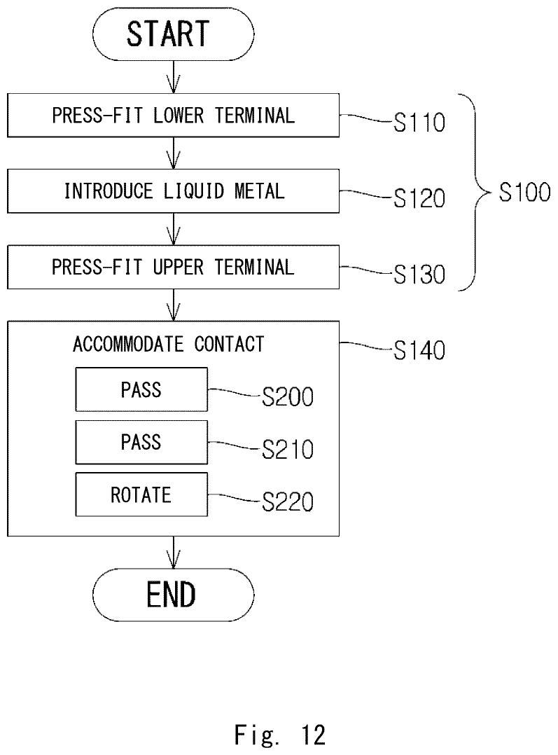

Referring next to FIG. 12, a method of manufacturing the interposer 1 is described hereinafter. Steps S100 to S130 are the same as Steps S100 to S130 in the above-described first embodiment and therefore not redundantly described below. In this embodiment, Step S140 of accommodating each contact 5 into the corresponding contact accommodation 6 is different from Step S140 in the above-described first embodiment. Specifically, Step S140 in this embodiment includes Step S200 for the large-diameter part 22 of the lower terminal 11 to pass through the three inward projections 30 and Step S210 for the large-diameter part 17 of the upper terminal 10 to pass through the three inward projections 30, and Step S220 of rotating the upper terminal 10 relative to the three inward projections 30 and thereby switching the upper terminal 10 from the passing position to the non-passing position.

The third embodiment is described above. The above-described third embodiment has the following features.

The two metal terminals (10, 11) include the upper terminal 10 (first metal terminal) and the lower terminal 11 (second metal terminal). On the inner peripheral surface 6A of each of the contact accommodations 6, the three inward projections 30 (first receiving part) that receives the large-diameter part 17 of the upper terminal 10 and the contact receiving flange 7 (second receiving part) that receives the large-diameter part 22 of the lower terminal 11 are formed. The large-diameter part 17 of the upper terminal 10 and the large-diameter part 22 of the lower terminal 11 are located between the three inward projections 30 and the contact receiving flange 7 in the vertical direction, and thereby the contact 5 is held by the housing 4.

This structure improves the handling of the interposer 1.

Further, by rotating the upper terminal 10 relative to the three inward projections 30, the position of the upper terminal 10 switches between the passing position where the large-diameter part 17 of the upper terminal 10 is allowed to pass through the three inward projections 30 in the vertical direction and the non-passing position where the large-diameter part 17 of the upper terminal 10 is not allowed to pass through the three inward projections 30 in the vertical direction. In this way, the structure in which the large-diameter part 17 of the upper terminal 10 and the large-diameter part 22 of the lower terminal 11 are located between the three inward projections 30 and the contact receiving flange 7 in the vertical direction is easily achieved.

Further, the interposer 1 is manufactured by attaching any one of the two metal terminals (10, 11) to the tube 12, filling the tube 12 with the liquid metal 13, attaching the other one of the two metal terminals (10, 11) to the tube 12, letting the upper terminal 10 pass through the three inward projections 30, and rotating the upper terminal 10 after it has passed therethrough to switch from the passing position to the non-passing position. This method allows reducing the manufacturing cost of the interposer 1.

The first to third embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector comprising:
a housing having a flat plate shape and including a plurality of contact accommodations penetrating the housing in a thickness direction; and
a plurality of contacts to be respectively accommodated in the plurality of contact accommodations of the housing, wherein
each of the contacts includes:
two metal terminals spaced apart from each other in the thickness direction of the housing;
a coupling member in a tubular shape being easily elastically deformable and coupling the two metal terminals; and
a conductive fluid filling an internal space of the coupling member,
the two metal terminals are electrically connected to each other through the conductive fluid,
a gas is present in the internal space of the coupling member, and
the two metal terminals are configured to approach each other in the thickness direction of the housing with compression of the gas and elastic deformation of the coupling member.

2. The connector according to claim 1, wherein the coupling member includes a first tubular portion and a second tubular portion, disposed at different positions in the thickness direction of the housing and having different thicknesses.

3. The connector according to claim 2, wherein the second tubular portion has a thinner thickness than the first tubular portion.

4. The connector according to claim 3, wherein the second tubular portion is disposed at at least one of two ends of the coupling member in the thickness direction of the housing.

5. The connector according to claim 4, wherein each metal terminal includes a press-fit part to be press-fitted into the coupling member, and the second tubular portion is disposed to face the press-fit part in a radial direction.

6. The connector according to claim 1, wherein each of the metal terminals includes a press-fit part to be press-fitted into the coupling member.

7. The connector according to claim 6, wherein each of the metal terminals includes a large-diameter part having a larger diameter than that of the press-fit part.

8. The connector according to claim 7, wherein
each of the metal terminals includes a contact part exposed outward from the housing, and
the press-fit part and the contact part are disposed back-to-back with the large-diameter part interposed therebetween.

9. The connector according to claim 7, wherein
each of the metal terminals includes a contact part exposed outward from the housing, and
the press-fit part and the contact part project in directions opposite to each other from the large-diameter part.

10. The connector according to claim 8, wherein the contact part has a smaller diameter than that of the large-diameter part.

11. The connector according to claim 10, wherein the plurality of contacts include a long contact having a first length in the thickness direction of the housing and a short contact having a second length shorter than the first length in the thickness direction of the housing.

12. The connector according to claim 10, wherein
the two metal terminals include a first metal terminal and a second metal terminal,
a plurality of inward projections to which the large-diameter part of the first metal terminal is to be press-fitted and a receiving part to receive the large-diameter part of the second metal terminal are formed on an inner peripheral surface of each of the contact accommodations, and
the large-diameter part of the first metal terminal is press-fitted to the plurality of inward projections, whereby the contact is held by the housing.

13. The connector according to claim 10, wherein
the two metal terminals include a first metal terminal and a second metal terminal,
a first receiving part to receive the large-diameter part of the first metal terminal and a second receiving part to receive the large-diameter part of the second metal terminal are formed on an inner peripheral surface of each of the contact accommodations, and
the large-diameter part of the first metal terminal and the large-diameter part of the second metal terminal are located between the first receiving part and the second receiving part in the thickness direction, whereby the contact is held by the housing.

14. The connector according to claim 13, wherein by rotating the first metal terminal relative to the first receiving part, the first metal terminal switches between a passing position where the large-diameter part of the first metal terminal is allowed to pass through the first receiving part in the thickness direction of the housing and a non-passing position where the large-diameter part of the first metal terminal is not allowed to pass through the first receiving part in the thickness direction of the housing.

15. The connector according to claim 1, wherein there is a gap between an inner peripheral surface of each of the contact accommodations and an outer peripheral surface of the coupling member of each of the contacts.

16. A method of manufacturing the connector according to claim 1, comprising:
attaching any one of the two metal terminals to the coupling member;
filling the internal space of the coupling member with the conductive fluid; and
attaching another one of the two metal terminals to the coupling member.

17. A method of manufacturing the connector according to claim 12, comprising:
attaching any one of the two metal terminals to the coupling member;
filling the internal space of the coupling member with the conductive fluid;
attaching another one of the two metal terminals to the coupling member; and
press-fitting the large-diameter part of the first metal terminal to the plurality of inward projections.

18. A method of manufacturing the connector according to claim 14, comprising:
attaching any one of the two metal terminals to the coupling member;
filling the internal space of the coupling member with the conductive fluid;
attaching another one of the two metal terminals to the coupling member;
letting the first metal terminal pass through the first receiving part; and
rotating the first metal terminal after the passing thereof to switch from the passing position to the non-passing position.
